(19) United States
(12) Patent Application Publication
(10) Pub. No.: US 2004/0157007 A1
(43) Pub. Date: Aug. 12, 2004

(54) Reusable mold and method for using same

(76) Inventor: Daniel Larocque, La Plaine (CA)

Correspondence Address: Daniel LAROCQUE, c/o PROTECTIONS EQUINOX INT'L INC., Suite 224, 4480, Cote-de-Liesse, Montreal, QC, H4N 2R1, CA

(21) Appl. No.: 10/772,329

(22) Filed: Feb. 6, 2004

Related U.S. Application Data
(60) Provisional application No. 60/445,434, filed on Feb. 7, 2003.

(51) Int. Cl. B29C 59/00

(52) U.S. Cl. 428/15; 249/187.1; 264/319

(57) ABSTRACT

A mold apparatus for manufacturing a surface patterned block. The apparatus includes a resilient template with a relief pattern supported in a support frame. A setting substrate is supported in the support frame and on the cloth template and has at least one moldable surface. The relief pattern contacts the moldable surface and transfers the relief pattern to the moldable surface to form the surface patterned block. A method of producing a patterned block and a patterned block are also provided.

### CROSS-REFERENCE TO RELATED APPLICATION

Benefit of U.S. Provisional Application for Patent, serial No. 60/445,434, filed on Feb. 7, 2003, is hereby claimed.

### FIELD OF THE INVENTION

The present invention concerns block molds and more particularly to a reusable mold for making surface patterned blocks.

### BACKGROUND OF THE INVENTION

Using concrete coping or paving stones on, for example, an upper edge of an in-ground swimming pool, is well known. Typically, a mold is first shaped to the desired shape and then concrete or other setting material is poured in. The material sets in the shape of the mold (the mold form) and the mold is then removed. To give the set material a more natural, weathered appearance, surface patterns may be added thereto. Oftentimes, private swimming pool owners desire the pool to be of a non-rectangular shape. Currently available molds are, however, of a standard rectangular shape, which limits the number of shaped blocks that is available to the user. It would, therefore, be useful to have molds, which may be used to make a series of non-rectangular shaped coping stones, which are then fitted together around the swimming pool edge. The surface patterns that mimic naturally occurring surfaces are difficult to add and often require the expertise of a stonemason or expensive molding technology. Disadvantageously, the mold forms that are currently available are single use and often of complex design that requires time consuming modifications on site. Moreover, for the stones to fit snuggly together, often the stonemason has to further work the stone edges.

Thus, there is a need for a reusable, inexpensive mold that is versatile and easy to use.

### SUMMARY OF THE INVENTION

The inventor has made the new and surprising discovery a method for producing curved coping stones using a novel reusable mold apparatus, which simultaneously adds surface patterns to the stones. The mold apparatus is constructed of inexpensive and readily available materials, such as drainage pipes used in the construction industry, plywood and the like. Advantageously, these materials are inherently resilient and allow the mold to be shaped into any desired shape, which substantially increases the number of block shapes available to the user and significantly decreases the costs associated with some of the aforesaid expensive molds. Moreover, a novel latex impregnated mold cloth imparts surface patterns on a plaster block during the setting process, which mimics the surface patterns of naturally occurring, hand-cut stone. Once a block is produced, the mold apparatus can be easily dismantled once used, cleaned, reassembled and reused.

Accordingly in a first aspect of the present invention, there is provided a mold apparatus for manufacturing a surface patterned block, the apparatus comprising:

a resilient template supported in a support frame, the resilient template having a relief pattern therein; and

a setting substrate, supported in the support frame and on the resilient template, the setting substrate having at least one moldable surface, the relief pattern contacting the moldable surface and transferring the relief pattern to the moldable surface so as to form the surface patterned block.

Typically, the support frame includes a base member with first and second spaced apart edges, a first end member and a second end member contacting the respective first and second spaced apart edges, the base member and the spaced apart end members being connected so as to define a hollow mold, the resilient template being located in the hollow mold.

Typically, the first edge of the base member has a first radius of curvature and the second edge of base member has a second radius of curvature, the second radius of curvature being larger than the first radius of curvature.

Typically, the second end member includes a support panel having first and second panel surfaces and a pad connected to the first panel surface, the pad facing inwardly towards the second base member edge.

Typically, the pad includes first and second surfaces, the first surface having thereon a surface pattern; the second surface being smooth.

Typically, the support panel is positioned generally orthogonal to the base member and against the second base member edge.

Typically, the support panel is made of a first resilient material.

Typically, the pad is made of a second resilient material.

Typically, pushing blocks are connected to the second panel surface to curve the support panel and the pad towards the first end member, the support panel and the pad having the same radius of curvature as the second radius of curvature.

Typically, the first end member is a resilient hollow tube having a concave recessed portion facing the second end member.

Typically, the hollow tube is positioned against the first edge of the base member and is curved away from the second end member, the hollow tube having a radius of curvature the same as the first radius of curvature.

Typically, the recessed portion has a rectangular opening which is sufficiently large to receive therein an amount of the setting substrate.

Typically, the resilient template includes a cloth embedded in a layer of latex having the relief pattern.

Typically, the resilient template includes a reinforcing wire mesh embedded in the layer of latex.

Typically, the relief pattern is a natural stone surface pattern.

Typically, the surface patterned block includes at least one patterned surface thereon.

Typically, the surface patterned block includes two curved edges and two smooth edges, one of the curved edges having the relief pattern thereon.

Typically, the curved edges are complementary to the first and second end members.

In another aspect of the first embodiment of the present invention, there is provided a mold apparatus for manufacturing a surface. patterned block, the apparatus comprising:

a support frame including a base member with first and second spaced apart edges, a first end member and a second end member contacting the respective first and second spaced apart edges, the base member and the spaced apart end members being connected so as to define a hollow mold for receiving a resilient template and a setting substrate.

In accordance with another aspect of the present invention, there is provided a method of making a surface patterned block, the method comprising:

transferring a relief pattern of a resilient template to a moldable surface of a setting substrate in contact with the relief pattern, the setting substrate being supported in the support frame, as described above, so as to form the surface patterned block.

In accordance with yet another aspect of the present invention, there is provided a surface patterned block manufactured using the method as described above.

### BRIEF DESCRIPTION OF THE DRAWINGS

Further aspects and advantages of the present invention will become better understood with reference to the description in association with the following Figures, in which:

FIG. 1 is a perspective view of a hollow tube used for constructing an embodiment of a mold;

FIG. 2 is an exploded perspective view of the mold;

FIG. 3 is a perspective view of a resilient mold template;

FIG. 4 is a perspective view the resilient mold template of FIG. 3 located in the mold;

FIG. 5 is a perspective view of a surface patterned block; and

FIG. 6 is a perspective view of a number of coping stones located on an upper edge of a swimming pool.

### DETAILED DESCRIPTION OF THE PREFERRED EMBODIMENTS

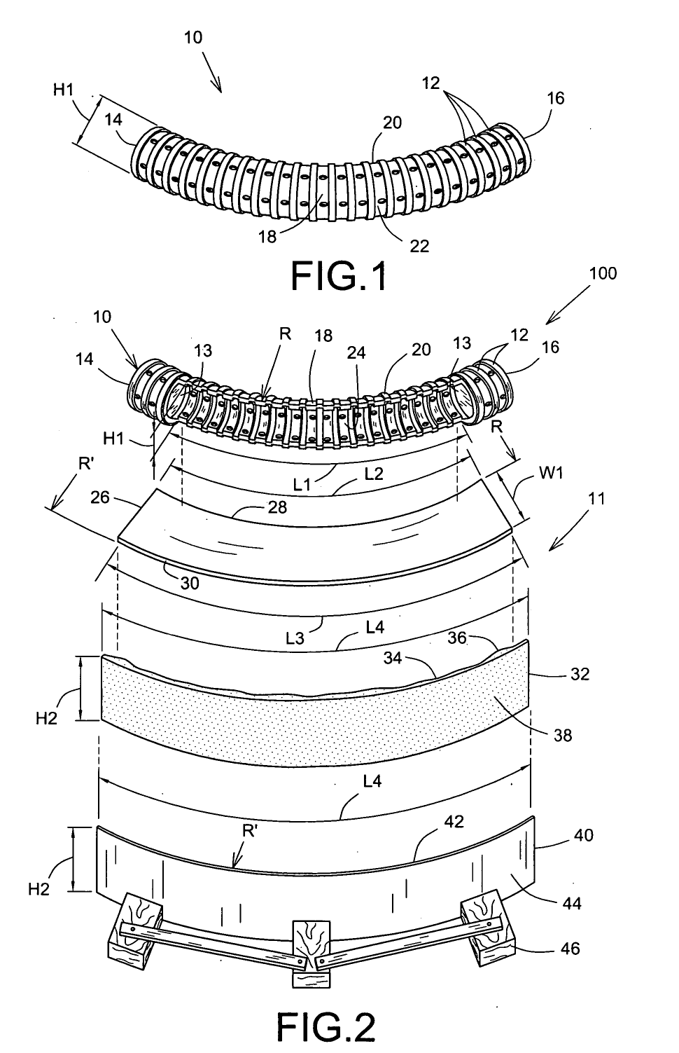

As illustrated in FIGS. 1, 2 and 4, an embodiment of a reusable mold apparatus for manufacturing a surface patterned block (or mold form) is shown generally at 100. Broadly speaking, the apparatus 100 includes a support frame 11 and a resilient mold template 50 supported therein. A setting substrate 62 such as concrete, plaster and the like, is loaded into the apparatus 100 and sets therein, as described in more detail below. The support frame 11 includes a first end member 10, a base member 26, a second end member 32, a support panel 40 and a number of pushing blocks 46.

The first end member 10 is typically a hollow tube, which is typically made of a polymer or plastic-like material such as those used in a variety of purposes in the construction or plumbing industry. In this embodiment, the hollow tube 10 is a flexible drainage tube, and a plurality of spaced apart ridges 12 and recesses along substantially the entire length of the inner and outer surfaces of the tube 10. These features give the tube 10 both resilience and rigidity. Depending on the desired shape of the block, the tube 10 can be manually straightened or bent to achieve a desired radius of curvature R. The tube 10 includes first and second ends 14, 16 with a central section 18 therebetween. The central section 18 includes respective concave and convex sections 20, 22.

As shown in FIG. 2, a cutaway (or recessed) portion 24 is located in the convex portion 22 of the sidewall in the tube 10. Typically, the cutaway section 24 is a rectangular concaved recess for receiving an amount of setting material (or setting substrate) 62, as will be described below. The cutaway portion 24 is of generally the same height H1 as the diameter of the tube 10 and of an arcuate length L1. Located at both ends of the cutaway portion 24 are two stoppers 13, which plug the tube 10 and prevent the flow of setting substrate 62 away from the cutaway portion 24. One skilled in the art will recognize that the base member 26 and the first end member 10 may be a single piece of material. One may also envisage the template end portion 10 as being a generally vertical wall orthogonal to the base member 26, so as to produce blocks having straight edges, as opposed to the rounded edges that are produced using the tube 10 described above.

In operation, the support frame 11 is temporarily constructed according to the following description and with reference to FIGS. 2 and 4. The tube 10 is located on a work platform (not shown) and the base member 26, typically planar and made out of paperboard such as corrugated/reinforced cardboard or the like, is positioned in a horizontal plane adjacent to the tube 10. The base member 26 is pre-cut to the desired swimming pool edge shape and serves as a basis for constructing the remaining elements of the mold apparatus 100. The base member 26 has a width W1, a first edge 28 and a second edge 30 spaced apart from the first edge 28. The first and second edges 28, 30 are generally curved and concentric with each other. The first edge 28 spans, at a minimum, the arcuate length L1 and has an arcuate length L2, which generally has the same radius R. The second edge 30 has an arcuate edge L3 of a radius of curvature R′ that is generally greater than the radius of curvature R. Typically, both lengths L2 and L3 encompass a same angle, and the length L3 is greater than L1 and greater than or equal to L2.

The second end member 32 is typically a pad, which is connected to a first panel surface 42 of the support panel 40 using adhesive or some other securing means known to those skilled in the art. The pad 32 is typically constructed from a resilient material, such as STYROFOAM™ or the like, that does not adhere to the setting substrate 62. The support panel 40 is made from a resilient material, for example, composite wood board or the like. The user positions and secures the hollow tube 10 on the base member 26. The support panel 40 is positioned against the base second edge 30 and is generally orthogonal to the base member 26. The pad 32 has a height H2 that is typically slightly larger than the internal height H1 of the tube 10. The pad 32 includes a first surface 34 that faces the base second edge 30. The first surface 34 optionally includes a manually carved or trimmed surface pattern 36 having irregularities that mimic naturally occurring surfaces such as those found on stone. The pad 32 also includes a second surface 38, which is generally smooth to allow for good contact with the support panel 40.

The support panel 40 is of a height H2 and includes a second panel surface 44. The pushing blocks 46 (three are shown in FIG. 1) are connected to the second panel surface 44. When secured to the work surface (not shown), the pushing blocks 46 ensure that the curvature of the pad 32 follows the radius R′ of the template second edge 30 by applying an inward retaining force against the support panel 40. The pad 32 and the support panel 40 are typically of the arcuate length L4, which is typically greater than L1, L2 and slightly greater than L3.

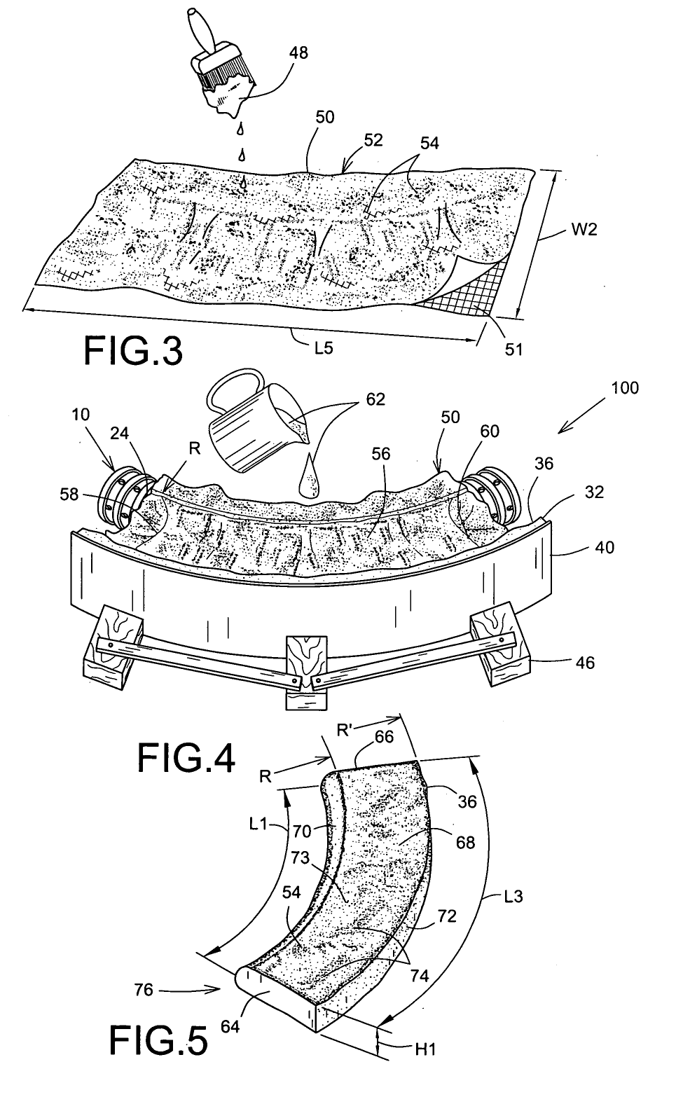

As illustrated in FIG. 3, the user prepares the resilient mold template 50 by applying layers of latex 48 onto a natural stone surface with a desirable natural stone surface pattern. Optionally, a lubricant (not illustrated) may be applied to the stone surface to aid removal of the resilient mold template 50. The layers of latex 48 are applied to form irregular relief patterns 54, which are the same as desirable natural stone surface pattern and which transfer the surface patterns into a moldable surface of the block (or mold form) 68 as the setting substrate sets. In the embodiment illustrated, the block 68 is a coping stone. The latex 48 typically has characteristics of drying without losing its shape such that the irregular relief patterns 54 will remain essentially intact. One skilled in the art will recognize that regular patterns may also be added to transfer surface patterns such as letters, geometrical figures and the like, to the moldable block surface. One skilled in the art will also understand that other types of material, which achieve the same function as latex, can be used.

As best illustrated in FIGS. 3 and 4, the layers of latex 48 have a width W2 and a length L5. Before the latex layer 48 is completely dried, a piece of cloth and/or reinforcing wire mesh 51 is laid over the latex layer 48 and embeds itself into the surface of the latex layer 48. The cloth 51 is typically made out of cotton fabric, gauze or cheesecloth and the like. Additional layers of latex 48 are typically laid over the previous ones and over the cloth and/or wire mesh, which forms, after complete drying of the latex layers, a resilient compounded template 52 with the relief patterns 54. The resilient compounded template 52 is sufficiently dimensioned to allow it to be inserted into the tube cutaway portion 24.

As illustrated in FIG. 4, when in use, the compounded template 52 covers the entire length L1 of the recessed end portion 24 of the concave section 20 of the hollow tube 10, from the cutaway portion 24 to the base second edge 30 over a length spanning, which is larger than the length L3. The user locates or wraps the compounded template 52 inside the tube recessed end portion 24. The base member 26, the pad 32 and the tube 10 when assembled form an opened-top and longitudinal end hollow mold 56 into which the compounded template 52 is located. Openings 58, 60 are located on each side of the hollow mold 56. A sufficient amount of the setting substrate 62 is poured into the hollow mold 56 to ensure that its level reaches the height H1 and is supported and held in the support frame 11. The setting substrate 62, during setting, includes at least one moldable surface that contacts the relief pattern 54 on the compounded template 52 and transfers the relief pattern 54 thereto as the setting substrate dries and sets.

As seen in FIG. 5, once the setting substrate 62 has dried, the block 68 with the surface pattern is removed from the hollow mold 56. The mold apparatus 100 can be disassembled and re-used to produce mold forms of different dimensions. The dried setting substrate 62 that has poured through the openings 58, 60 is removed using a saw or the like, thus cutting the mold form 68 to produce two straight, longitudinal smooth edges 64, 66.

As shown on FIG. 5, the mold form 68 of height H1 results. The mold form 68 is complementary to the internal dimensions of the reusable mold apparatus 100. In the embodiment illustrated, the mold form 68 includes first and second curved edge surfaces 70, 72, which generally follow the first and second radii of curvature R and R′, respectively, which substantially have arcuate lengths L1 and L3 respectively. The first edge surface 70 has a convex rounded shape, commonly called a “bull nose”, along its length L1 as given by the recessed end portion 24 of the tube concave section 20. The surface pattern 36 of the pad 32 and the surface relief pattern 54 of the compounded cloth 52 are translated onto the corresponding edge surfaces 72, 70 of the mold form 68, as well as onto a mold form top surface 73. If required, further surface patterns can be applied to the mold form 68 by carving into the surfaces 70, 73 to create other patterns 74. The resulting mold form 68 has an improved aesthetic appearance created by the relief patterns 54 and 74 and give surface patterns similar to naturally occurring stone. Other irregularities in the pad surface pattern 36 may also be transferred to an upper edge 72 of the mold form 68. This gives the mold form 68 the appearance of being hand-cut. As is well known in the art, the mold form 68 may then be used in a casting process to produce a concrete replica coping stone of the mold form 68.

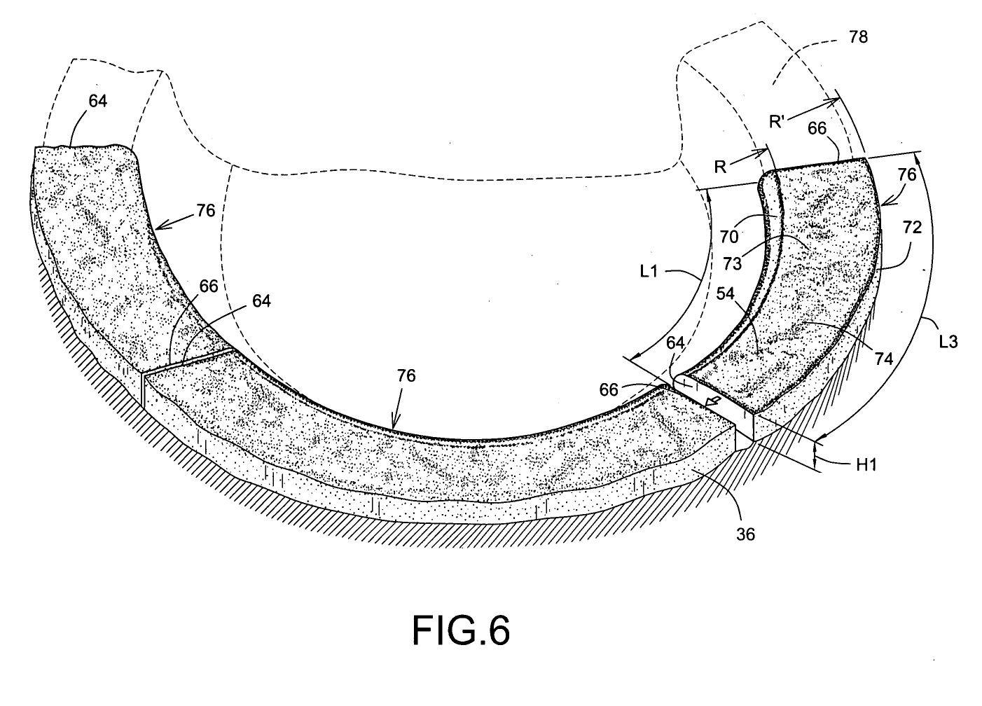

As shown in FIG. 6, a series of coping stones 76, which are produced by the method of the present invention, are shown positioned around an upper edge 78 of an in-ground swimming pool. One skilled in the art will recognize that the shape, dimensions and the surface patterns of the coping stones 76 can be varied by changing the size and shape of the reusable mold apparatus 100 and the compounded cloth 52. The coping stones 76 are positioned over the edge 78 of the swimming pool and secured thereto, using for example, bonding cement, mortar or glue. A waterproof sealant (not shown) may also be injected between the two smooth edges 64, 66 of two adjacent coping stones 76.

While a specific embodiment has been described, those skilled in the art will recognize many alterations that could be made within the spirit of the invention, which is defined solely according to the following claims.

I claim:

1. A mold apparatus for manufacturing a surface patterned block, the apparatus comprising:
a resilient template supported in a support frame, the resilient template having a relief pattern therein; and
a setting substrate, supported in the support frame and on the resilient template, the setting substrate having at least one moldable surface, the relief pattern contacting the moldable surface and transferring the relief pattern to the moldable surface so as to form the surface patterned block.

2. The apparatus, according to claim 1, in which the support frame includes a base member with first and second spaced apart edges, a first end member and a second end member contacting the respective first and second spaced apart edges, the base member and the spaced apart end members being connected so as to define a hollow mold, the resilient template being located in the hollow mold.

3. The apparatus, according to claim 2, in which the first edge of the base member has a first radius of curvature and the second edge of base member has a second radius of curvature, the second radius of curvature being larger than the first radius of curvature.

4. The apparatus, according to claim 3, in which the second end member includes a support panel having first and second panel surfaces and a pad connected to the first panel surface, the pad facing inwardly towards the second base member edge.

5. The apparatus, according to claim 4, in which the pad includes first and second surfaces, the first surface having thereon a surface pattern, the second surface being smooth.

6. The apparatus, according to claim 5, in which the support panel is positioned generally orthogonal to the base member and against the second base member edge.

7. The apparatus, according to claim 6, in which the support panel is made of a first resilient material.

8. The apparatus, according to claim 7, in which the pad is made of a second resilient material.

9. The apparatus, according to claims 8, in which pushing blocks are connected to the second panel surface to curve the support panel and the pad towards the first end member, the support panel and the pad having the same radius of curvature as the second radius of curvature.

10. The apparatus, according claim 9, in which the first end member is a resilient hollow tube having a concave recessed portion facing the second end member.

11. The apparatus, according to claim 10, in which the hollow tube is positioned against the first edge of the base member and is curved away from the second end member, the hollow tube having a radius of curvature the same as the first radius of curvature.

12. The apparatus, according to claim 11, in which the recessed portion has a rectangular opening which is sufficiently large to receive therein an amount of the setting substrate.

13. The apparatus, according to claim 12, in which the resilient template includes a cloth embedded in a layer of latex having the relief pattern.

14. The apparatus, according to claim 13, in which the resilient template includes a reinforcing wire mesh embedded in the layer of latex.

15. The apparatus, according to claim 14, in which the relief pattern is a natural stone surface pattern.

16. The apparatus, according to claim 1, in which the surface patterned block includes at least one patterned surface thereon.

17. The apparatus, according to claim 16, in which the surface patterned block includes two curved edges and two smooth edges, one of the curved edges having the relief pattern thereon.

18. The apparatus, according to claim 17, in which the curved edges are complementary to the first and second end members.

19. A mold apparatus for manufacturing a surface patterned block, the apparatus comprising:
a support frame including a base member with first and second spaced apart edges, a first end member and a second end member contacting the respective first and second spaced apart edges, the base member and the spaced apart end members being connected so as to define a hollow mold for receiving a resilient template and a setting substrate.

20. The apparatus, according to claim 19, in which the resilient template includes a relief pattern for contacting a moldable surface on the setting substrate, supported in the support frame and on the resilient template, the relief pattern being transferred to the moldable surface so as to form the surface patterned block.

21. The apparatus, according to claim 20, in which the first edge of the base member has a first radius of curvature and the second edge of base member has a second radius of curvature, the second radius of curvature being larger than the first radius of curvature.

22. The apparatus, according to claim 21, in which the second end member includes a support panel having first and second panel surfaces and a pad connected to the first panel surface, the pad facing inwardly towards the second base member edge.

23. The apparatus, according to claim 22, in which the pad includes first and second surfaces, the first surface having thereon a surface pattern, the second surface being smooth.

24. The apparatus, according to claim 23, in which the support panel is positioned generally orthogonal to the base member and against the second base member edge.

25. The apparatus, according to claim 24, in which the support panel is made of a first resilient material.

26. The apparatus, according to claim 25, in which the pad is made of a second resilient material.

27. The apparatus, according to claims 26, in which pushing blocks are connected to the second panel surface to curve the support panel and the pad towards the first end member, the support panel and the pad having the same radius of curvature as the second radius of curvature.

28. The apparatus, according claim 27, in which the first end member is a resilient hollow tube having a concave recessed portion facing the second end member.

29. The apparatus, according to claim 28, in which the hollow tube is positioned against the first edge of the base member and is curved away from the second end member, the hollow tube having a radius of curvature the same as the first radius of curvature.

30. The apparatus, according to claim 29, in which the recessed portion has a rectangular opening which is sufficiently large to receive therein an amount of the setting substrate.

31. The apparatus, according to claim 30, in which the resilient template includes a cloth embedded in a layer of latex having the relief pattern.

32. The apparatus, according to claim 31, in which the resilient template includes a reinforcing wire mesh embedded in the layer of latex.

33. The apparatus, according to claim 32, in which the relief pattern is a natural stone surface pattern.

34. The apparatus, according to claim 19, in which the surface patterned block includes at least one patterned surface thereon.

35. The apparatus, according to claim 34, in which the surface patterned block includes two curved edges and two smooth edges, one of the curved edges having the relief pattern thereon.

36. The apparatus, according to claim 35, in which the curved edges are complementary to the first and second end members.

37. A method of making a surface patterned block, the method comprising:
transferring a relief pattern of a resilient template to a moldable surface of a setting substrate in contact with the relief pattern, the setting substrate being supported in the support frame, according to claim 1, so as to form the surface patterned block.

38. The method, according to claim 37, in which the relief pattern is produced by adding a layer of latex onto a natural stone having a natural stone surface pattern.

39. The method, according to claim 38, further includes embedding a cloth in the layer of latex.

40. The method, according to claim 39, further includes embedding a reinforcing wire mesh in the layer of latex.

41. The method, according to claim 40, in which the surface patterned block includes at least one patterned surface thereon.

42. The method, according to claim 41, in which the surface patterned block includes two curved edges and two smooth edges, one of the curved edges having the relief pattern thereon.

43. The method, according to claim 42, in which the curved edges are complementary to the first and second end members.

44. A surface patterned block manufactured using the method, according to claim 37.

45. The block, according to claim 44, in which the surface patterned block includes at least one patterned surface thereon.

46. The block, according to claim 45, in which the surface patterned block includes two curved edges and two smooth edges, one of the curved edges having the relief pattern thereon.

47. The block, according to claim 46, in which the curved edges are complementary to the first and second end members.

48. The block, according to claim 47, is a coping stone.
